(19) United States
(12) Patent Application Publication
(10) Pub. No.: US 2025/0342346 A1
(43) Pub. Date: Nov. 6, 2025

(54) CROSS-MODALITY ALIGNMENT FOR LARGE LANGUAGE MODELS

(71) Applicant: NVIDIA Corporation, Santa Clara, CA (US)

(72) Inventors: Hongxu Yin, San Jose, CA (US); Pavlo Molchanov, Mountain View, CA (US); Song Han, Somerville, MA (US); Yao Lu, Palo Alto, CA (US); Hanrong Ye, Clear Water Bay (HK); Andrew Tao, Los Altos, CA (US); Wei Ping, Sunnyvale, CA (US); Jan Kautz, Lexington, MA (US); De-An Huang, Cupertino, CA (US); Zhiding Yu, Santa Clara, CA (US)

(21) Appl. No.: 19/005,809

(22) Filed: Dec. 30, 2024

Related U.S. Application Data
(60) Provisional application No. 63/640,950, filed on May 1, 2024.

(51) Int. Cl. G06N 3/0455; G06N 3/0475

(52) U.S. Cl. CPC G06N 3/0455; G06N 3/0475

(57) ABSTRACT

Apparatuses, systems, and techniques for cross-modality alignment for large language models (LLMs), enabling enhanced multi-modal interaction. In at least one embodiment, a textual embedding is obtained by encoding a multi-modal input and algining the encoded results into a textual embedding space. A visual embedding is obtained based on features extracted from visual data in the multi-modal input using visual encoders. A multi-modal output is generated based on the textual embedding and the visual embedding.

### CLAIM OF PRIORITY

This application claims the benefit of U.S. Provisional Application No. 63/640,950 titled “Cross-Modality Alignment for Large Language Models,” filed May 1, 2024, the entire contents of which are incorporated herein by reference.

### BACKGROUND

Large language models (LLMs) provide an emerging foundation for enhancing various deep learning tasks beyond the realm of natural language processing. As an example, the research community has been quickly extending the fast progress of LLMs towards the computer vision (CV) domain. The introduction of LLMs in CV tasks enables vision models to perform many zero/few-shot and in-context learning tasks that are “promptable” through user questions, potentially empowering reasoning capabilities for the first time. Despite remarkable progress, cross-modality alignment is still a challenging task. The joint training stage for cross-modality learning requires carefully designed feedback signal to guide the connected foundation models, backed by cross-modality datasets at scale. Hence, the majority of existing studies revolve around a solitary input modality linked to LLMs, with the output being solely text. For example, existing frameworks like FLAMINGO, LLAVA, and VILA, delve into image input, while VIDEO-GPT specifically concentrates on video input. Exploring the integration of various modalities into a cohesive framework is a crucial yet relatively unexplored research challenge in the domain of multi-modal LLMs.

### SUMMARY

Embodiments of the present disclosure relate to cross-modality alignment for large language models (LLMs). Systems and methods are disclosed that enable cross-modality understanding, reasoning, and generation through the alignment of modality-specific encoders with LLM inputs and modality-specific decoders with LLM outputs. The alignment involves both textual alignment and visual alignment. The former aligns encoded information from different modalities into a textual embedding space, while the latter utilizes a visual embedding highway (VEH) network to pass features extracted from one or more visual encoders to the visual decoder(s), thereby addressing the current issues of significant visual information loss associated with conventional technologies.

### BRIEF DESCRIPTION OF THE DRAWINGS

The present systems and methods for cross-modality alignment for large language models are described in detail below with reference to the attached drawing figures, wherein:

FIG. 1A illustrates a block diagram of a multi-modal interaction system suitable for use in implementing some embodiments of the present disclosure;

FIG. 1B illustrates a flow diagram of a framework for multi-modal interaction, in accordance with an embodiment;

FIG. 1C illustrates a flowchart of a method for decoding and generating visual outputs using a visual decoder, in accordance with an embodiment;

FIG. 2A illustrates examples of user interactions with a multi-modal interaction system, in accordance with an embodiment;

FIG. 2B illustrates examples of data included in a training dataset, in accordance with an embodiment;

FIG. 2C illustrates an example of interleaved multi-modality data sequences, in accordance with an embodiment;

FIG. 3A illustrates a flowchart of a method for training a multi-modal interaction system, in accordance with an embodiment;

FIG. 3B illustrates a flowchart of a method for multi-modal interaction, in accordance with an embodiment;

FIG. 4 illustrates an example parallel processing unit suitable for use in implementing some embodiments of the present disclosure;

FIG. 5A is a conceptual diagram of a processing system implemented using the PPU of FIG. 4, suitable for use in implementing some embodiments of the present disclosure;

FIG. 5B illustrates an exemplary system in which the various architecture and/or functionality of the various previous embodiments may be implemented;

FIG. 5C illustrates components of an exemplary system that can be used to train and utilize machine learning, in at least one embodiment; and

FIG. 6 illustrates an exemplary streaming system suitable for use in implementing some embodiments of the present disclosure.

### DETAILED DESCRIPTION

Systems and methods are disclosed herein that relate to cross-modality alignment for large language models (LLMs), and in particular, to the alignment of modality-specific encoders with LLM inputs and diffusion decoders with LLM outputs, thereby enhancing LLM capabilities, e.g., in perception, understanding, and generation across video, image, language, and audio domains.

In at least one embodiment, systems and methods are disclosed that implement a multi-modal interaction framework integrating multiple modalities, such as text, image, video, and audio, into an LLM at both the input and output stages. The multi-modal interaction framework aligns modality-specific encoders with LLM inputs and modality-specific decoders with LLM outputs through textual alignment and visual alignment. Textual alignment aligns encoded information from different modalities into a textual embedding space. Visual alignment utilizes a visual embedding highway (VEH) network to pass features extracted from one or more visual encoders to the visual decoder(s) to enhance the visual output.

In at least one embodiment, the multi-modal interaction framework generates visual controller signals and textual controller signals by using a visual controller module and a textual controller module, respectively. The visual controller module generates the visual controller signals based on visual embedding obtained by the VEH network. The textual controller module generates the textual controller signals based on textual controller embedding corresponding to the output of the LLM. The multi-modal interaction framework provides the visual controller signals and textual controller signals to the modality-specific decoders for generating multi-modal output. In at least one embodiment, a visual decoder (e.g., an image decoder or video decoder) performs decoding at various stages based on visual controller signals and textual controller signals to generate visual output. In at least one embodiment, a visual decoder (e.g., an image decoder or video decoder) or another decoder performs decoding at various stages based solely on textual controller signals to generate the corresponding output.

In at least one embodiment, the multi-modal interaction framework is trained through various phases, including encoder-LLM-decoder alignment training, interleaved data pre-training, and X-to-X cross-modality instruction fine-tuning. Different training datasets are used to facilitate the training at various phases. A first training dataset includes various types of cross-modality understanding and generation tasks, such as video-to-image, video-to-video, image-to-video, video-to-audio, audio-to-video, and image+audio-to-video tasks. A second training dataset includes interleaved multi-modality data sequences sampled from video clips.

By utilizing the VEH network, the visual decoder can decode outputs from the LLM in a way that leverages features extracted from the visual encoder. This approach preserves low-level visual details (e.g., color, pattern, style, etc.) available from the visual encoder, which are highly beneficial for generating consistent content at the output. Furthermore, by adopting a three-phase training scheme with a specifically designed X-to-X training dataset and interleaved training dataset, the multi-modal interaction framework can be effectively trained and fine-tuned for both textual and visual alignment. This is because the training scheme and datasets are specifically designed for the network architecture, including the visual alignment mechanism, and consider its interaction with other components in the framework. Compared to prior art techniques for multi-modal interaction, the combination of utilizing the VEH network and adopting the three-phase training scheme with custom-designed training datasets provides notably enhanced visual consistency.

According to a first aspect, the present disclosure provides a computer-implemented method for multi-modal interaction. The method includes receiving input that includes visual data, generating one or more first textual tokens corresponding to the visual data, generating, by a large language model (LLM) and based on the one or more first textual tokens, one or more first output tokens, generating, by a visual encoder and based on the visual data, one or more layers of visual features; generating, by a visual embedding highway (VEH) network and based on the one or more layers of visual features, one or more visual controller signals, and decoding, by a visual decoder and based on the one or more visual controller signals, the one or more first output tokens to generate visual output.

In at least one embodiment, the visual decoder includes a plurality of neural network layers, and the plurality of neural network layers include a set of downsampling layers and a set of upsampling layers. Each downsampling layer of the set of downsampling layers in the visual decoder receives a visual controller signal of the one or more visual controller signals from the VEH network. Each visual control signal includes a layer of visual features of the one or more layers of visual features from the visual encoder.

In at least one embodiment, the method further includes generating, based on the one or more first output tokens, one or more textual controller signals. The decoding, by the visual decoder, the one or more first output tokens to generate the visual output is further based on the one or more textual controller signals. Each downsampling layer of the set of downsampling layers in the visual decoder further receives a textual controller signal of the one or more textual controller signals. Each upsampling layer of the set of upsampling layers receives a textual controller signal of the one or more textual controller signals.

In at least one embodiment, the visual data includes at least one of image data or video data.

In at least one embodiment, the generating the one or more first textual tokens includes encoding, by the visual encoder, the visual data to generate a visual token sequence comprising one or more visual tokens, and projecting, by a first visual projector, the one or more visual tokens into a textual embedding space to provide the one or more first textual tokens.

In at least one embodiment, the visual encoder includes at least one of an image encoder or a video encoder. The visual decoder includes at least one of an image decoder or a video decoder.

In at least one embodiment, the method further includes projecting, by a second visual projector, the one or more first output tokens from the textual embedding space into an embedding space corresponding to the visual decoder.

In at least one embodiment, the method further includes at a first stage and using a first training dataset, training a plurality of first projectors, a plurality of second projectors, and a vocabulary embedding layer of the LLM. The plurality of first projectors include the first visual projector. The plurality of second projectors include the second visual projector. The method additionally includes at a second stage, training the first and second projectors and fine-tuning the LLM, using a second training dataset, and at a third stage, first fine-tuning the first projectors, the second projectors, and the LLM using the first training dataset, and then fine-tuning the visual decoder and the VEH network. The visual decoder includes at least one of an image decoder or a video decoder.

In at least one embodiment, the first training dataset includes cross-modality understanding and generation tasks. The cross-modality understanding and generation tasks include video to image tasks, video to video tasks, image to video tasks, video to audio tasks, audio to video tasks, and image and audio to video tasks. The second training dataset includes sets of data sequences sampled from a plurality of video clips. Each set of data sequences are sampled from a video clip of the plurality of video clips. Each data sequence includes image, audio, video, and text input corresponding to a segment of the video clip. The set of data sequences correspond to different segments of the corresponding video clip. At the second stage, the LLM is configured to predict missing segments of the plurality of video clips based on the sets of data sequences.

In at least one embodiment, the method further includes generating, by the LLM, one or more second output tokens based on the visual token sequence. The one or more second output tokens correspond to a modality different from the modality of the one or more first output tokens. The method additional includes generating additional output corresponding to the one or more second output tokens.

In at least one embodiment, the method further includes text data. The method further includes encoding, by a tokenizer, the text data to generate a text token sequence in a textual embedding space. The text token sequence includes one or more second textual tokens. The method additional includes generating, by the LLM and based on the one or more first textual tokens and the one or more second textual tokens, textual output.

In at least one embodiment, the input further includes audio data. The method further includes encoding, by an audio encoder, the audio data to generate an audio token sequence comprising one or more audio tokens, projecting, by an audio projector, the one or more audio tokens into a textual embedding space to provide one or more second textual tokens, generating, by the LLM and based on the one or more first textual tokens and the one or more second textual tokens, one or more second output tokens, and generating audio output based on the one or more second output tokens.

According to a second aspect, the present disclosure provides a system for multi-modal interaction. The system includes one or more processors configured to perform, using one or more neural networks, generation of a multi-modal output based on input. The one or more neural networks include a visual encoder configured to encode visual input to generate a visual token sequence that includes one or more visual tokens, and generate, based on the visual input, one or more layers of visual features. The one or more neural networks further include a first visual projector configured to project the one or more visual tokens into a textual embedding space to provide one or more first textual tokens. The one or more first textual tokens correspond to the visual input. The one or more neural networks additionally include a large language model (LLM) configured to generate one or more first output tokens based on the one or more first textual tokens, a visual embedding highway (VEH) network configured to generate, based on the one or more layers of visual features, one or more visual controller signals, and a visual decoder configured to decode, based on the one or more visual controller signals, the one or more first output tokens to generate visual output.

In at least one embodiment, the visual decoder includes a plurality of neural network layers, and the plurality of neural network layers include a set of downsampling layers and a set of upsampling layers. Each downsampling layer of the set of downsampling layers in the visual decoder receives a visual controller signal of the one or more visual controller signals from the VEH network. each visual control signal includes a layer of visual features of the one or more layers of visual features from a visual encoder.

In at least one embodiment, the LLM is further configured to generate, based on the one or more first output tokens, one or more textual controller signals. The visual decoder is further configured to decode the one or more first output tokens based on the one or more textual controller signals. Each downsampling layer of the set of downsampling layers in the visual decoder further receives a textual controller signal of the one or more textual controller signals. Each upsampling layer of the set of upsampling layers receives a textual controller signal of the one or more textual controller signals.

In at least one embodiment, the visual input includes at least one of image data or video data.

In at least one embodiment, the LLM is further configured to generate one or more second output tokens based on the visual token sequence. The one or more second output tokens correspond to a modality different from the modality of the one or more first output tokens. The LLM is additionally configured to generate additional output corresponding to the one or more second output tokens.

In at least one embodiment, the visual encoder includes at least one of an image encoder or a video encoder. The visual decoder includes at least one of an image decoder or a video decoder.

In at least one embodiment, the one or more neural networks further include a second visual projector configured to project the one or more first output tokens from the textual embedding space into an embedding space corresponding to the visual decoder.

In at least one embodiment, the one or more neural networks further include a tokenizer configured to encode text input to generate a text token sequence that includes one or more second textual tokens in the textual embedding space, an audio encoder configured to encode audio input to generate an audio token sequence that includes one or more audio tokens, and a first audio projector configured to project the one or more audio token into the textual embedding space to provide one or more third textual tokens corresponding to the audio input. The LLM is further configured to generate one or more second output tokens corresponding to the one or more second textual tokens and one or more third output tokens corresponding to the one or more third textual tokens. The one or more neural networks further include a second audio projector configured to project the one or more third output tokens from the textual embedding space into an embedding space corresponding to an audio decoder, and the audio decoder configured to decode the one or more third output tokens to generate audio output.

In at least one embodiment, the one or more neural networks are trained by training, at a first stage, a plurality of first projectors, a plurality of second projectors, and a vocabulary embedding layer of the LLM, using a first training dataset. The plurality of first projectors include the first visual projector. The plurality of second projectors include the second visual projector. The one or more neural networks are further trained by training, at a second stage, the first and second projectors, using a second training dataset. The one or more neural networks are additionally trained by at a third stage, first fine-tuning the first projectors, the second projectors, and the LLM using the first training dataset, and then fine-tuning the visual decoder and the VEH network. The visual decoder includes at least one of an image decoder or a video decoder.

In at least one embodiment, the first training dataset includes cross-modality understanding and generation tasks. The cross-modality understanding and generation tasks include video to image tasks, video to video tasks, image to video tasks, video to audio tasks, audio to video tasks, and image and audio to video tasks. The second training dataset includes sets of data sequences sampled from a plurality of video clips. Each set of data sequences are sampled from a video clip of the plurality of video clips. Each data sequence includes image, audio, video, and text input corresponding to a segment of the video clip. The set of data sequences correspond to different segments of the corresponding video clip. At the second stage, the LLM is configured to predict missing segments of the plurality of video clips based on the sets of data sequences.

According to a third aspect, the present disclosure provides a non-transitory computer readable medium having stored thereon a set of instructions that, if performed by one or more processors, cause the one or more processors to perform the computer-implemented method for multi-modal interaction according to the first aspect and any embodiment thereof.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

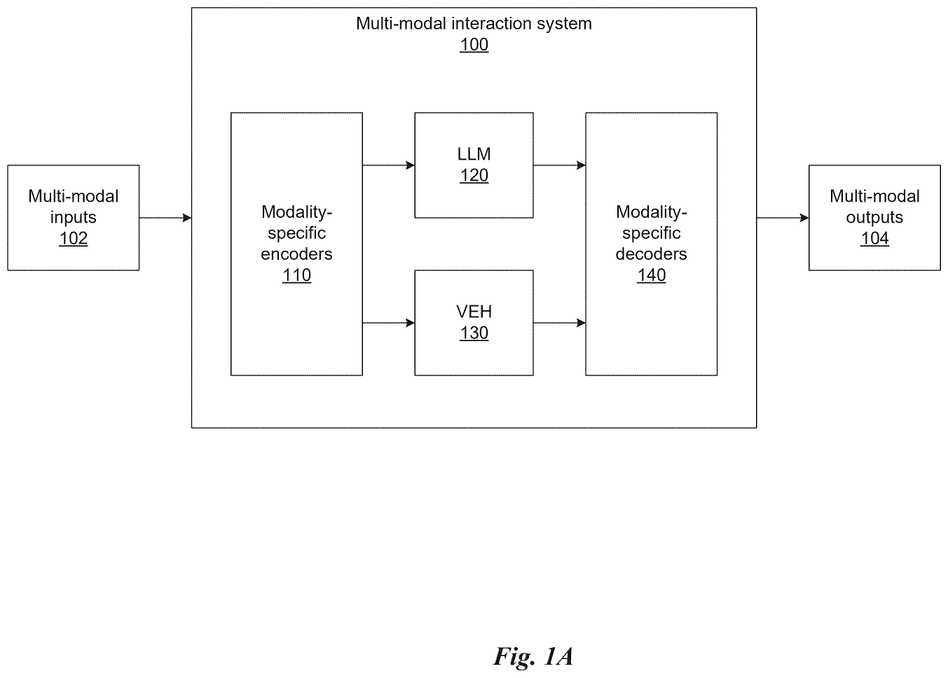

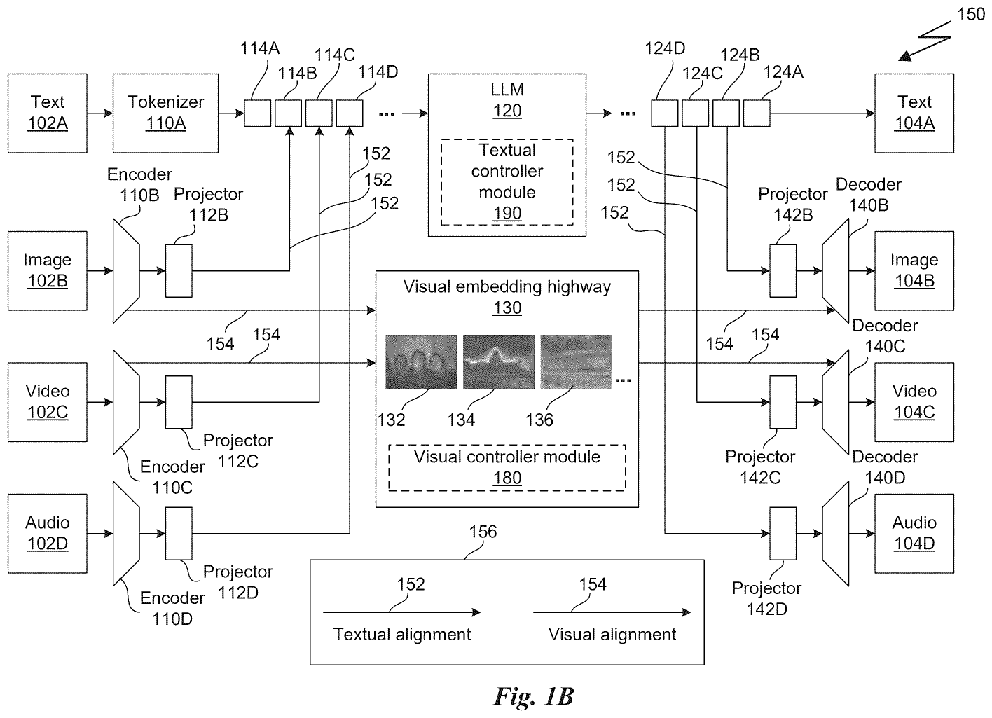

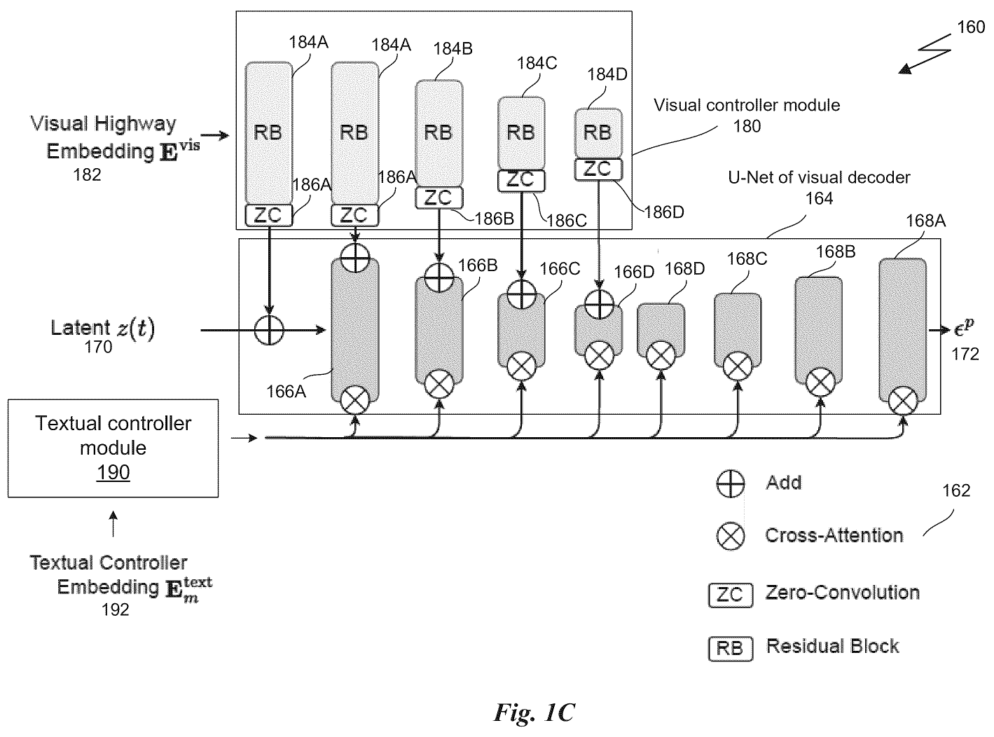

FIG. 1A illustrates a block diagram of a multi-modal interaction system 100 suitable for use in implementing some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the multi-modal interaction system 100 is within the scope and spirit of embodiments of the present disclosure.

The system 100 includes various functional modules, such as one or more modality-specific encoders 110, an LLM 120, a VEH module 130, and modality-specific decoders 140. The system 100 is configured to process multi-modal inputs 102 and generate multi-modal outputs 104.

The multi-modal inputs 102 include inputs of various modalities, such as, text, image, video, and audio. In at least one embodiment, the multi-modal inputs 102 include user inputs, outputs from the system 100 based on previous multi-modal inputs 102, or a combination thereof.

Upon receiving the multi-modal inputs 102, the system 100 uses the modality-specific encoders 110 to extracts feature from the multi-modal inputs 102 and aligns them into a unified embedding space, allowing for the sharing of these features across diverse modalities. Each modality is associated with a corresponding modality-specific encoder of the modality-specific encoders 110. In at least one embodiment, the unified embedding space is a textual embedding space. The modality-specific encoder 110 for text is referred to as a tokenizer. For certain modalities, after being encoded by their corresponding modality-specific encoders 110, they are further projected into the textual embedding space via their respective projection layers (or projectors). In at least one embodiment, the modality-specific encoders 110 are pre-trained models that are fine-tuned with the projection layers (with learnable networks) to facilitate the encoding and alignment of features within the unified embedding space.

Outputs of the modality-specific encoders 110 (or the corresponding projection layers) are referred to as tokens. The tokens aligned in the textual embedding space form textual embedding inputs to the LLM 120. The LLM 120 generates a textual embedding output that includes one or more generation tokens in the textual embedding space. The one or more generation tokens from the textual embedding output are decoded using the modality-specific decoders 140 to generate the multi-modal outputs 104. Similarly, for certain modalities, before being decoded by their corresponding modality-specific decoders 140, they are projected from the textual embedding space to their appropriate embedding space via their respective projection layers. It should be noted that the input and/or output of the multi-modal interaction system 100 can include single or multi-modal data. Accordingly, some or all of the encoders and/or decoders in system 100 can be used under various circumstances.

VEH 130 is configured to pass features extracted from a visual encoder(s) (e.g., image and/or video encoders) to a corresponding visual decoder(s), thereby enhancing the generation of visual outputs (e.g., image or video) by the system 100.

FIG. 1B illustrates a functional block diagram of a framework 150 for multi-modal interaction, in accordance with an embodiment. Each block of framework 150, described herein, is configured to perform one or more computing processes using any combination of hardware, firmware, and/or software. For instance, various functions may be carried out by a processor executing instructions stored in memory. The framework may also be embodied as computer-usable instructions stored on computer storage media. The framework may be provided by a standalone application, a service or hosted service (standalone or in combination with another hosted service), or a plug-in to another product, to name a few. In addition, framework 150 is described, by way of example, with respect to the system of FIG. 1A. However, this framework may additionally or alternatively be executed by any one system, or any combination of systems, including, but not limited to, those described herein. Furthermore, persons of ordinary skill in the art will understand that any system that performs framework 150 is within the scope and spirit of embodiments of the present disclosure.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

The framework 150 may be referred to as “X-VILA,” where “VILA” stands for Video, Image, Language, and Audio modalities, respectively, while “X” denotes the focus on alignment across all the modalities, from input encoders to output decoders, using LLM space. The central tenet of X-VILA is an alignment-oriented architecture to augment an LLM 120 with the versatile ability to “see/hear/read” multi-modality inputs and “draw/speak/write” multi-modality outputs, as shown in FIG. 1B.

The framework 150 is designed for cross modality perception, understanding, and generation in the multi-modal domains. The framework 150 implements both textual alignment and visual alignment to enhance the generation of multi-modal outputs 104 based on multi-modal inputs 102. As indicated by legend 156, textual alignment is represented by arrows labelled 152, while visual alignment is represented by arrows labelled 154. Textual alignment 152 involves aligning tokens from various modalities into a unified embedding space, such as a textual embedding space. Visual alignment leverages extracted visual features from the visual encoder (e.g., the image encoder and/or video encoder) to guide generation at the visual decoder (e.g., the image decoder and/or video decoder).

With reference to FIG. 1A, the multi-modal inputs 102 includes one or more of text 102A, image 102B, video 102C, or audio 102D. The modality-specific encoders 110 include a tokenizer 110A, an image encoder 110B, a video encoder 110C, and an audio encoder 110D. The tokenizer 110A encodes an input text 102A to generate a text token sequence 114A. The text token sequence 114A includes one or more text tokens. For example, the text token sequence 114A is represented by a high-dimensional embedding consisting of one or more vectors, with each vector corresponding to a text token. The image encoder 110B encodes an input image 102B to generate an image token sequence 114B. The image token sequence 114B includes one or more image tokens. The image token sequence 114B is projected into a textual embedding space corresponding to the tokenizer 110A through a projector 112B. That is, the projector 112B maps image representations (e.g., output from the image encoder 110B) into an embedding space compatible with textual representations (e.g., output from the tokenizer 110A). Similarly, the video encoder 110C encodes an input video 102C to generate a video token sequence 114C. The video token sequence 114C includes one or more video tokens. The video token sequence 114C is projected into the textual embedding space corresponding to the tokenizer 110A through a projector 112C. The audio encoder 110D encodes an input audio 102D to generate an audio token sequence 114D. The audio token sequence 114D includes one or more audio tokens. The audio token(s) 114D is projected into the textual embedding space corresponding to the tokenizer 110A through a projector 112D.

A textual embedding input is formed based on the tokens aligned in the textual embedding space, which serves as input to the LLM 120. The LLM 120 then generates a corresponding textual embedding output. The textual embedding output includes generated tokens of one or more modalities, collectively referred to as generation tokens (e.g., 124A, 124B, 124C, and 124D). The generation tokens are processed by the modality-specific decoders 140 to generate the multi-modal outputs 104. For example, a text output 104A is generated based on one or more generation text token 124A. An image output 104B is generated by projecting one or more generation image tokens 124B from the textual embedding space to the embedding space corresponding to the image decoder 140B, using a projector 142B, and by decoding the one or more generation image tokens 124B with the image decoder 140B. A video output 104C is generated by projecting one or more generation video tokens 124C from the textual embedding space to the embedding space corresponding to the video decoder 140C, using a projector 142C, and by decoding the one or more generation video tokens 124C with the video decoder 140C. An audio output 104D is generated by projecting one or more generation audio tokens 124D from the textual embedding space to the embedding space corresponding to the audio decoder 140D, using a projector 142D, and by decoding the one or more generation audio tokens 124D with the image decoder 140D.

As such, the framework 150 adopts a set of modality-specific encoders (110A-110D) to process signals (or inputs) from different modalities (102A-102D) and feed the extracted information (114A-114D) into the LLM 120, and deploy a series of modality-specific decoders (140A-140D) to translate the generated tokens (e.g., generation tokens 124A-124D) from the LLM 120 into content in the respective modalities (e.g., corresponding to outputs 104A-104D). The encoders (110A-110D), LLM 120, and decoders (140A-140D) are connected using a novel two-phase alignment mechanism, including the textual alignment and visual alignment.

The framework 150 employs the textual alignment to compress or project the multi-modality inputs 102 into the textual embedding space. This enables the LLM 120 to effectively process the multi-modality inputs 102. However, the textual alignment alone unfortunately results in the loss of a substantial amount of visual detailed information. This is primarily due to the inherent limitations of textual embeddings, which have a significantly smaller capacity to store such visual nuances. To alleviate the visual information loss in the textual alignment process, the framework 150 employs an effective visual alignment mechanism by building a direct visual embedding highway (VEH) 130 from visual encoders (110B and 110C) to visual decoders (140B and 140C). This design greatly preserves the low-level visual details (e.g., color, pattern, style, etc.), which are highly beneficial for generating consistent content. As will be elaborated with reference to FIG. 1C, in at least one embodiment, a textual controller module 190 and a visual controller module 180 are utilized to generate respective control signals to guide the modality-specific decoders for output generation. The visual controller module 180 can be a network integrated in the VEH 130, as depicted in FIG. 1B. Alternatively, the visual controller module 180 can be a separate network connected between the VEH 130 and one or more visual decoders (e.g., 140B and 140C). The textual controller module 190 can be a network integrated in the LLM 120, as depicted in FIG. 1B. Alternatively, the textual controller module 190 can be a separate network connected between the LLM 120 and one or more modality-specific decoders (e.g., 140B, 140C, and 140D).

In at least one embodiment, the multi-modal inputs 102 includes visual data, such as image 102B and/or video 102C. As such, the textual embedding input is formed by at least an image token sequence 114B or a video token sequence 114C. While encoding the visual input, the image encoder 110B and/or the video encoder 110C extract features (e.g., feature maps 132, 134, and 136) from the visual data and pass the extracted features to the VEH 130. The VEH 130 then passes the extracted features and/or generates control signals to the visual decoder(s) (e.g., the image decoder 140B and/or video decoder 140C) for the generation of visual outputs, such as image output 104B and/or video output 104C. As such, the VEH 130 provides additional visual information for output generation. This allows the framework 150 to align the visual features between the input and output stages.

In at least one embodiment, the textual embedding input is formed by a text token sequence 114A, an image token sequence 114B, a video token sequence 114C, and an audio token sequence 114D. The textual embedding output includes one or more generation text tokens 124A, one or more generation image tokens 124B, one or more generation video tokens 124C, and one or more generation audio tokens 124D.

In at least one embodiment, the framework 150 receives input of a first modality and generates output including one or more other modalities. For example, the framework 150 can generate a text output 104A, an image output 104B, a video output 104C, and an audio output 104D, based on a single-modality input, such as a text input 102A, an image input 102B, a video input 102C, or an audio input 102D. In at least one embodiment, the framework 150 can generate a multi-modality output 104, which includes all four modalities, based on inputs from two or more modalities. The VEH 130 can be activated when the multi-modality input 102 includes visual input, such as the image input 102B and/or the video input 102C.

In at least one embodiment, the modality-specific encoders 110A-110D include pre-trained domain expert encoders. Encoders are specialized models or systems tailored for specific fields or areas of expertise, referred to as “domains.” These encoders can leverage their pre-trained understanding ability to process information, recognize patterns, and make inferences based on their training. For each modality m∈{‘text’, ‘image’, ‘video’, ‘audio’}, the corresponding encoder is denoted as Encₘ. In at least one embodiment, the encoder for text modality is a text tokenizer (e.g., 110A), while the encoders for other modalities can be transformer-based models. The projectors 112B-112D, denoted as

$${P}_{m}^{i n} ,$$

each include modality-specific trainable linear layers. The projectors 112B-112D project corresponding encoder outputs into embedding sequences(S) in the textual embedding space of the subsequent LLM 120. The embedding sequence(s) (S) is referred to as the textual embedding input, formulated as:

$${S}^{i n} = \{ {P}_{m}^{i n} ( E n {c}_{m} ( {X}_{m} ) ) \} , \qquad ( Eq . l )$$

where Xₘ is input from different modalities m∈{‘text’, ‘image’, ‘video’, ‘audio’}.

The LLM 120 serves as the “brain” of the framework 150. The LLM 120 processes information from the textual embedding space and predicts language outputs correspondingly. The autoregressive process of generating an output embedding sequence (S^{out}) by the LLM 120 is formulated as:

$${S}^{out} = LLM ( {S}^{i n} ) . \qquad ( Eq . 2 )$$

The framework 150 generates multi-modality outputs, other than text, based on the modality-specific generation tokens (e.g., generation tokens 124B-124D). Other than generation text tokens 124A, there are three types of modality-specific generation tokens: image generation tokens 124B, represented by {[IMG;], i∈[1, N_{img}]}, video generation tokens 124C, represented by {[VIDᵢ], i∈[1, N_{vid}]}, and audio generation tokens 124D, represented by {[AUDᵢ], i∈[1, N_{aud}]}. These modality-specific generation tokens (124B-124D) are added to the vocabulary of the LLM 120 as the LLM 120 processes them, for example, during training. The LLM 120 is trained to predict when to generate the modality-specific generation tokens, and the generation tokens are then translated for the synthesis of image, video, or audio, via a set of modality-specific decoders (140B-140D). In at least one embodiment, the modality-specific decoders (140B-140D) include generation models, such as diffusion models.

In at least one embodiment, the framework 150 extracts a subset of the output embedding sequence (S^{out}) corresponding to the aforementioned generation tokens of modality m. This subset sequence of modality m is denoted as

$${S}_{m}^{g e n} .$$

The framework 150 utilizes modality-specific transformer layers, denoted as output projection layers

$${P}_{m}^{out} ,$$

to project

$${S}_{m}^{g e n}$$

to the feature space of the original pre-trained modality-specific encoder of the modality-specific decoder. The resulting embedding is used to control the modality-specific decoder via cross-attention, and this embedding vector is referred to as “textual controller embedding,” denoted as

$${E}_{m}^{text} .$$

The process for obtaining the textural controller embedding

$$( {E}_{m}^{text} )$$

is formulated as follows:

$${E}_{m}^{text} = {P}_{m}^{out} ( {S}_{m}^{g e n} ) . \qquad ( Eq . 3 )$$

In at least one embodiment, the framework 150 obtains layer-wise feature maps (e.g., 132, 134, 136, etc.) from the visual encoder(s) (e.g., 110B and/or 110C) and adds up these features as visual embedding, denoted as E^{vis} (e.g., 182 as shown in FIG. 1C). Eᵥᵢₛ is defined with dimensions H×W×C, where H and W represent feature height and width, respectively, and C represents the embedding vector. The visual encoder downsamples features from the visual input, resulting in decreased spatial dimensions of the residual blocks while their depths increase as the layers get deeper. The framework 150 implements a visual controller module (e.g., 180 as shown in FIG. 1C) to control the visual decoder. In at least one embodiment, the visual controller module includes four stages, where each stage includes two residual convolutional blocks. The residual convolutional blocks (e.g., 184A, 184B, 184C, or 184D as shown in FIG. 1C) have cascading spatial dimensions that align with the resolution settings in the U-Net encoder of the visual decoder (e.g., the image decoder 140B or the video decoder 140C). In cach stage, the convolutional block (e.g., 186A, 186B, 186C, or 186D as shown in FIG. 1C) are initialized with zero weights. This block generates output control signals for the stage, which are initially zero at the start of the training. These control signals are added to different stages of the U-Net (164 as shown in FIG. 1C).

FIG. 1C illustrates a functional block diagram of a system 160 for decoding and generating visual outputs using a visual decoder, in accordance with an embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the system 160 is within the scope and spirit of embodiments of the present disclosure.

In at least an embodiment, system 160 is a subsystem of system 100, as shown in FIG. 1A. The blocks of system 160 are part of the functional blocks of framework 150, as shown in FIG. 1B. The visual encoder can be embodied as the image decoder 140B and/or the video decoder 140C. The visual controller module 180 can be a network integrated in the VEH 130, as depicted in FIG. 1B. Alternatively, the visual controller module 180 can be a separate network connected between the VEH 130 and one or more visual decoders (e.g., 140B and 140C). The textual controller module 190 can be a network integrated in the LLM 120, as depicted in FIG. 1B. Alternatively, the textual controller module 190 can be a separate network connected between the LLM 120 and one or more modality-specific decoders (e.g., 140B, 140C, and 140D).

In at least an embodiment, the LLM 120 and VEH 130 provide appropriate control signals, through the textual controller module 190 and the visual controller module 180, respectively, to guide the output generation process, such as through the modality-specific decoders 140, as shown in FIGS. 1A and 1B. In at least one embodiment, diffusion decoders are used for decoding image, video, and audio related outputs from the LLM 120. Each diffusion decoder includes a neural network that has a plurality of layers, with each layer controlled by one or more control signals generated from the LLM 120 and/or VEH 130 outputs.

Referring to FIG. 1C, the visual decoder includes a U-Net architecture 164 that has four downsampling layers (166A-166D) and four upsampling layers (168A-168D). A U-Net architecture is a convolutional neural network designed for image segmentation, featuring a symmetric encoder-decoder structure with skip connections that combine downsampled feature maps from the encoder with upsampled outputs from the decoder, enabling precise localization and improved segmentation accuracy.

The input to the visual decoder is a latent 170 at reverse step t, represented by z (t). In at least one embodiment, the system 100 (or the framework 150) obtains the latent 170 based on one or more corresponding generation tokens (e.g., from image or video modality). The output of the visual decoder is noise (EP) 172 that is predicted by the U-Net 164. Each layer in the U-Net 164 is controlled by one or more control signals from the corresponding controller module(s). The controller modules for controlling the visual decoder include a visual controller module 180 and a textual controller module 190. The visual controller module 180 generates visual control signals based on results from the VEH 130, while the textual controller module 190 generates textual control signals based on results from the LLM 120. The visual controller module 180 can be a functional module coupled to or integrated in the VEH 130. Similarly, the textual controller module 190 can be a functional module coupled to or integrated in the LLM 120. In at least one embodiment, the audio decoder (e.g., 140D as depicted in FIG. 1B) includes a similar U-Net model as the U-Net 164, while the audio decoding can be controlled solely by the textual controller module 190.

The visual encoder, during encoding, generates layer-wise feature maps. The VEH 130 obtains the layer-wise feature maps from the visual encoder and adds up these features as visual embedding (E^{vis}) 182. The visual controller module 180 processes the visual embedding (E^{vis}) to generate visual control signals.

In at least one embodiment, the visual controller module 180 includes four stages, with each stage including a residual block (184A, 184B, 184C, or 184D) whose dimensions match the resolution setting in a corresponding (down-sampling) layer (e.g., 166A, 166B, 166C, or 166D, respectively) in the U-Net 164. The residual block (184A, 184B, 184C, or 184D) at each stage is paired with a zero-convolution block (e.g., 186A, 186B, 186C, or 186D). Legend 162 indicates the symbols used to represent operations such as “add” and “cross-attention,” as well as components “residual block” and “zero-convolution” in FIG. 1C. The zero-convolution blocks (186A, 186B, 186C, and 186D) in the visual controller module 180 generate visual control signals for different stages, with each visual control signal controlling the corresponding layer in the U-Net 164 during the decoding process.

The textual controller module 190 obtains textual controller embedding

$$( {E}_{m}^{text} )$$

192 based on the output embedding sequence (S^{out}) from the LLM 120. The textual controller embedding

$$( {E}_{m}^{text} )$$

192 is the subset of the output embedding sequence (S^{out}) corresponding to the generation tokens of modality m.

The decoding process performed by the U-Net 164 illustrated in FIG. 1C is a noise prediction process. The noise prediction process in each reverse step t in the visual decoder can be formulated as:

$${ϵ}^{p} = U - Ne t ( z ( t ) , {E}^{v i s} , {E}_{m}^{text} ) , m ∈ \{ ‘ image ’ , ‘ video ’ \} , \qquad ( Eq . 4 )$$

where ∈^{p} is the predicted noise given input latent z(t). The predicted noise (∈^{p}) from the diffusion model corresponds to the content generated for the output of the respective modality.

In at least one embodiment, the RB 184A, corresponding to the first layer-wise feature map encoded by the visual encoder, is first added to the latent 170. Then, in the U-Net 164, cach of the downsampling stages (166A-166D) is controlled by both a visual control signal output from the respective ZC block (e.g., 186A, 186B, 186C, or 186D) of the visual controller module 180 and a textual control signal provided by the textual controller module 190. The following upsampling stages of the U-Net 164 are each controlled by a textual control signal from the textual controller module 190. In at least one embodiment, the visual control signal output from a ZC block is associated with the addition of extracted features to the corresponding downsampling layer of the U-Net 164, while the textual control signal is associated with a cross-attention operation to allow the downsampling layer of the U-Net 164 to attend to the textual features.

In at least one embodiment, a visual decoder (e.g., an image decoder or video decoder) or another decoder performs decoding based solely on textual controller signals to generate output. For example, when there is no visual input, the VEH 130 may not be activated and therefore provide no information, thus the visual decoder receives only textual controller signals for generating the visual output.

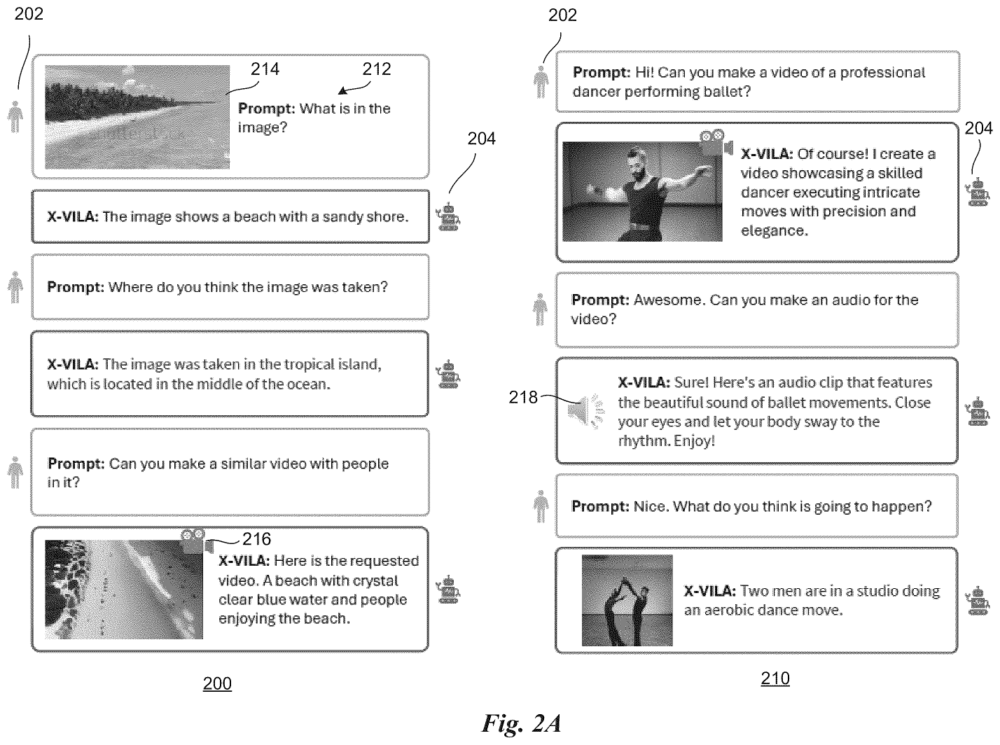

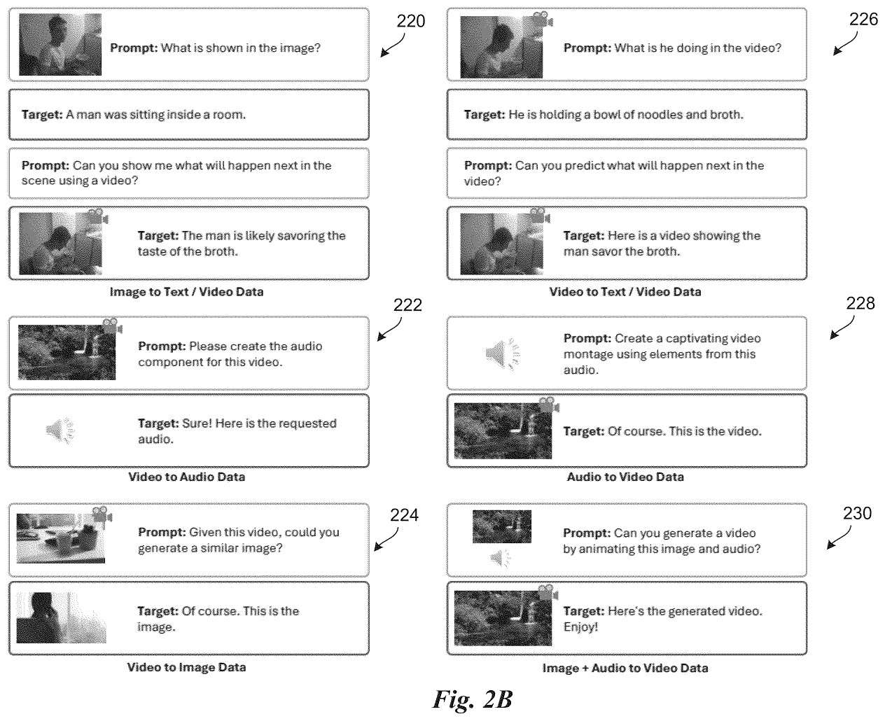

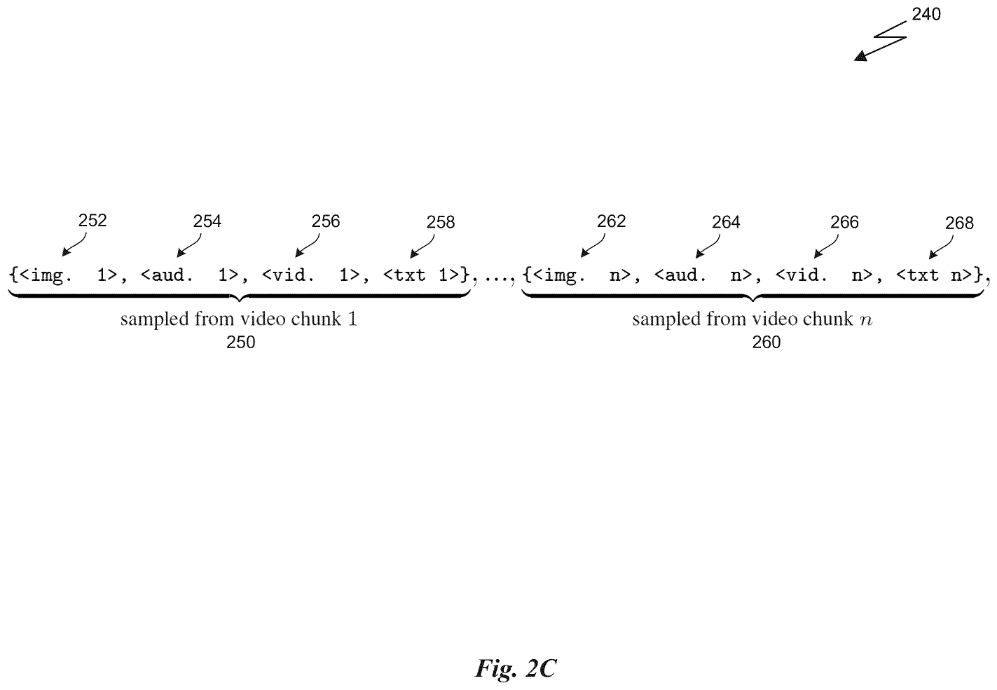

FIG. 2A illustrates examples of user interactions with a multi-modal interaction system, in accordance with an embodiment. The multi-modal interaction system, referred to as X-VILA, may be embodied as the multi-modal interaction system 100 as depicted in FIG. 1A, and/or a system that implements the framework 150 as illustrated in FIG. 1B. In at least one embodiment, a training database can include similar data, where the response from the multi-modal interaction system (e.g., X-VILA) may be predefined and used as ground truth.

User inputs are indicated by a human symbol 202, while responses generated by X-VILA is represented by a robot symbol 204. Interaction examples 200 and 210 include multi-modality inputs/outputs, such as text 212, image 214, video 216, and audio 218. In example 200, X-VILA generates a visual output (e.g., a video 216) that corresponds to the previous visual input (e.g., an image 214) by the user 202. In example 210, X-VILA generates a visual output (e.g., an image) that corresponds to a previously generated audio by the X-VILA 204.

Various training datasets are constructed and utilized at different phases of training.

A first dataset, referred to as the X-to-X dataset, encompasses six types of cross-modality understanding and generation tasks. The six types of cross-modality understanding and generation tasks include video-to-image, video-to-video, image-to-video, video-to-audio, audio-to-video, image+audio-to-video tasks.

FIG. 2B illustrates examples of data included in a training dataset, in accordance with an embodiment. The training dataset is referred to as an X-to-X dataset. Example 220 shows image to text/video data, example 222 shows video to audio data, example 224 shows video to image data, example 226 shows video to text/video data, example 228 shows audio to video data, and example 230 shows image and audio to video data.

The X-to-X dataset is created to address the challenge posed by the scarcity of cross-modality instruction-following data in the development of any-to-any modality (or “X-to-X”) LLMs. Existing datasets provide limited data, mostly in the form of X-to-text or text-to-X. This limitation severely restricts the progress in creating LLMs that can seamlessly handle multiple modalities in both input and output ends. The new X-to-X dataset is a multi-modality instruction tuning dataset, which is proven effective for cross-modality alignment. This dataset serves as a valuable resource for future research in the realm of multi-modality foundation models. In at least one embodiment, X-to-X dataset can include data that is curated based on existing multi-modality dataset, such as a dataset including short videos with textual descriptions sourced from the web or a dataset that connects videos to a series of temporally annotated sentence descriptions). In an embodiment, an X-to-X dataset is synthesized with more than 1.5 million multi-modality conversations, with each conversation containing one or more cross-modality question-and-answer pairs.

In at least one embodiment, a second dataset, referred to as a multi-modality interleaved corpus (e.g., a large and structured set of data), is constructed for a one or more training phases (e.g., an interleaved data pre-training phase). The multi-modality interleaved corpus includes interleaved multi-modality data sequences sampled from video clips. Each video clip is sampled into one or more video chunks, with each video chunk corresponding to a specific segment of the video clip. Each video chunk is represented by a sequence of data includes an image, audio, video, and text. In an embodiment, the interleaved corpus is constructed based on an existing database containing captioned video clips. The second database exploits the nature of video that contains sequential flow of text (e.g., captions), audio, short video, and image. This enables the construction of the interleaved corpus that interleaves images/videos with text.

FIG. 2C illustrates an example of interleaved multi-modality data sequences, in accordance with an embodiment. Video chunks 1-n (e.g., as indicated by 250 and 260) are sampled from a video clip. Sampled video chunk 1 250 is represented by a data sequence that includes image 252 (denoted by <img. 1>), audio 254 (denoted by <aud.1>), video 256 (denoted by <vid.1>), and text 258 (denoted by <txt.1>). Similarly, sampled video chunk n 260 is represented by a data sequence that includes image 262 (denoted by <img.n>), audio 264 (denoted by <aud.n>), video 266 (denoted by <vid.n>), and text 268 (denoted by <txt.n>).

In at least one embodiment, the video chunks 1-n are sampled from an entire video clip that offers natural sources of interleaved cross-modality data structure. The sampled video chunks are used to train the multi-modal interaction system (e.g., the system 100 as illustrated in FIG. 1A) to predict missing segments in the corresponding video clip. In an embodiment, even sampling method and n=3 were adopted to generate interleaved multi-modality data sequences for each video clip, thereby constructing cross-modality tasks for the beginning, middle stage, and ending of the video clip.

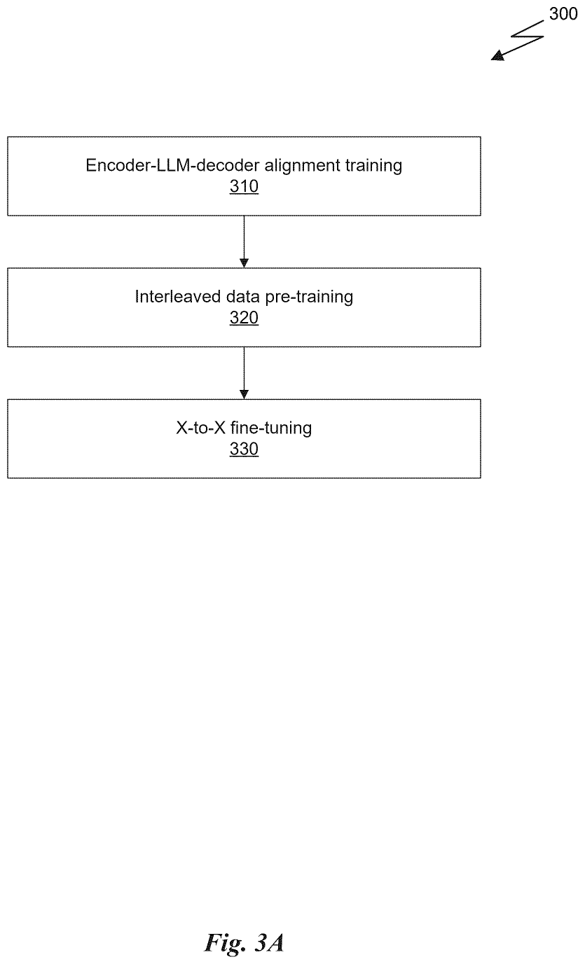

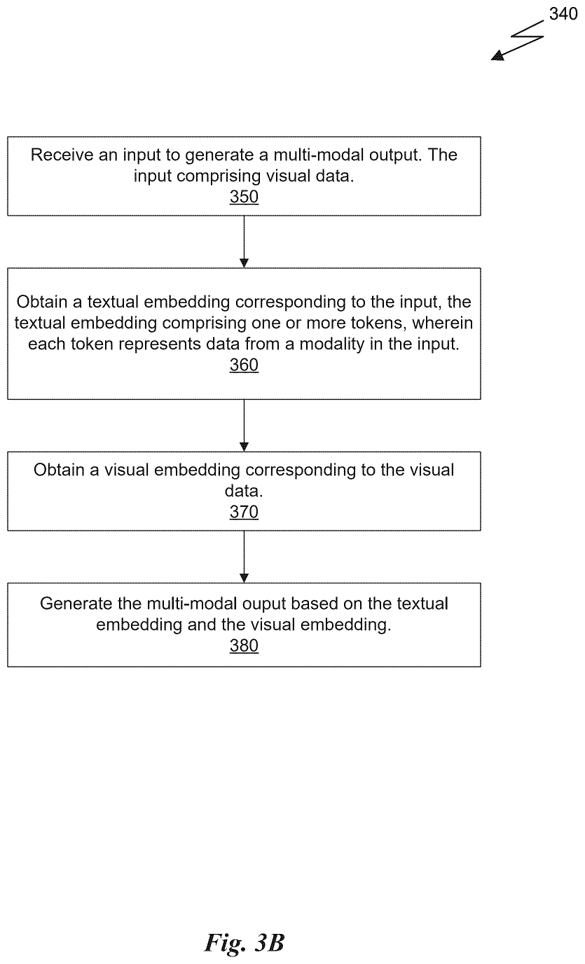

FIG. 3A illustrates a flowchart of a method 300 for training a multi-modal interaction system, in accordance with an embodiment. Each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1A. However, this method may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure. In at least an embodiment, the system 100 of FIG. 1A implements the framework 150 of FIG. 1B to perform the method 300.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

As shown in FIG. 3A, the system 100 can be trained in three phases, namely (i) encoder-LLM-decoder alignment training at block 310, (ii) interleaved data pre-training at block 320, and (iii) X-to-X fine-tuning (or X-to-X cross-modality instruction fine-tuning) at block 330.

At block 310, the encoder-LLM-decoder alignment training trains the input projection layers (e.g., projectors 112B, 112C, and 112D), output projection layers (e.g., projectors 142B, 142C, and 142D), and the vocabulary embedding layer of LLM 120, while all other parameters are frozen. This training phase aims to minimize the feature distance between the textual controller embedding Eₘ^{text} generated by the output projection layers (e.g., projectors 142B, 142C, and 142D) and the embedding generated by the original pre-trained text encoder of a diffusion model. In at least one embodiment, the system 100 is trained using the X-to-X dataset or other suitable cross-modality datasets in this training phase.

At block 320, the interleaved data pre-training jointly trains the input and output projection layers (e.g., projectors 112B, 112C, and 112D, along with projectors 142B, 142C, and 142D), while fine-tuning the LLM 120. In at least one embodiment, the LLM 120 can be fine-tuned by updating a low-rank adaption (LoRA) module implemented in the LLM 120. An interleaved training dataset, as discussed above, can be used for training in this phase. In an embodiment, the system 100 is provided with sampled, interleaved multi-modality data sequences for a video clip, corresponding to the beginning, middle, and end stages of the video clip, respectively. The system 100 is then trained to predict interleaved multi-modality data sequences for the missing segments between the sampled portions. This training phase aligns various targets for gradient computation and optimizes network projector alignment.

At block 330, the X-to-X fine-tuning aims to fine-tune the system 100 for both textual alignment and visual alignment. This training phase involves two steps. The first step aims to fine-tune the textual alignment of the system 100. This step is similar to the encoder-LLM-decoder alignment training phase (in block 310), except that the training dataset now uses the X-to-X dataset for cross-modality generation instruction tuning. The second step aims to fine-tune the visual alignment. During training, the parameters of the visual decoders (e.g., 140B and 140C) and the visual controller module (e.g., 180 as depicted in FIG. 1C) are updated, while all other network parameters are fixed, including the input and output projection layers (e.g., projectors 112B-112D and projectors 142B-142D) and the LLM 120. The objective is to minimize the difference(s) between the visual output(s) generated by the visual decoder(s) and original visual input(s) to the corresponding visual encoder(s).

FIG. 3B illustrates a flowchart of a method 340 for multi-modal interaction, in accordance with an embodiment. Each block of method 340, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 340 is described, by way of example, with respect to the system of FIG. 1A. However, this method may additionally or alternatively be executed by any one system, or any combination of systems, including, but not limited to, those described herein. Furthermore, persons of ordinary skill in the art will understand that any system that performs method 340 is within the scope and spirit of embodiments of the present disclosure. In at least an embodiment, the system 100 of FIG. 1A implements the framework 150 of FIG. 1B to perform the method 340.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

At block 350, the system 100 receives an input to generate a multi-modal output. The input includes visual data, such as image and/or video. In at least one embodiment, the input includes text 102A, image 102B, video 102C, audio 102D, or any combination thereof. Similarly, the multi-modal output includes text 104A, image 104B, video 104C, audio 104D, or any combination thereof.

At block 360, the system 100 obtains a textual embedding corresponding to the input. The textual embedding includes one or more tokens encoded based on the input. Each token represents data from a modality in the input. In at least one embodiment, the textual embedding including token sequences 114A, 114B, 114C, and/or 114D.

Each modality of data in the input is encoded into a respective token. Visual data is encoded into a visual token(s) using a corresponding visual encoder(s). For example, the tokens can be generated by the encoders (or tokenizer) and projectors as illustrated in FIG. 1B.

At block 370, the system 100 obtains a visual embedding corresponding to the visual data. In at least an embodiment, the system 100 obtains the visual embedding based on features encoded by the visual encoder(s) from the visual data. For example, the system 100 obtains the visual embedding using the VEH 130 as illustrated in FIG. 1B.

At block 380, the system 100 generates the multi-modal output based on the textual embedding and the visual embedding. In at least an embodiment, the system 100 performs the functions of the system 160 as illustrated in FIG. 1C to generate visual output, such as image and/or video output.

### Parallel Processing Architecture

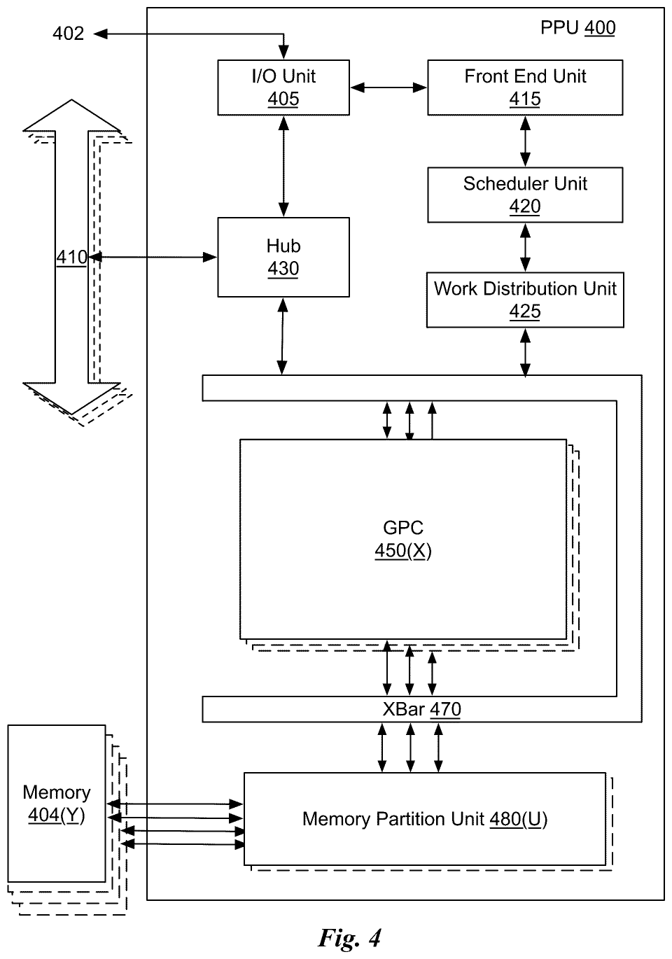

FIG. 4 illustrates a parallel processing unit (PPU) 400, in accordance with an embodiment. In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

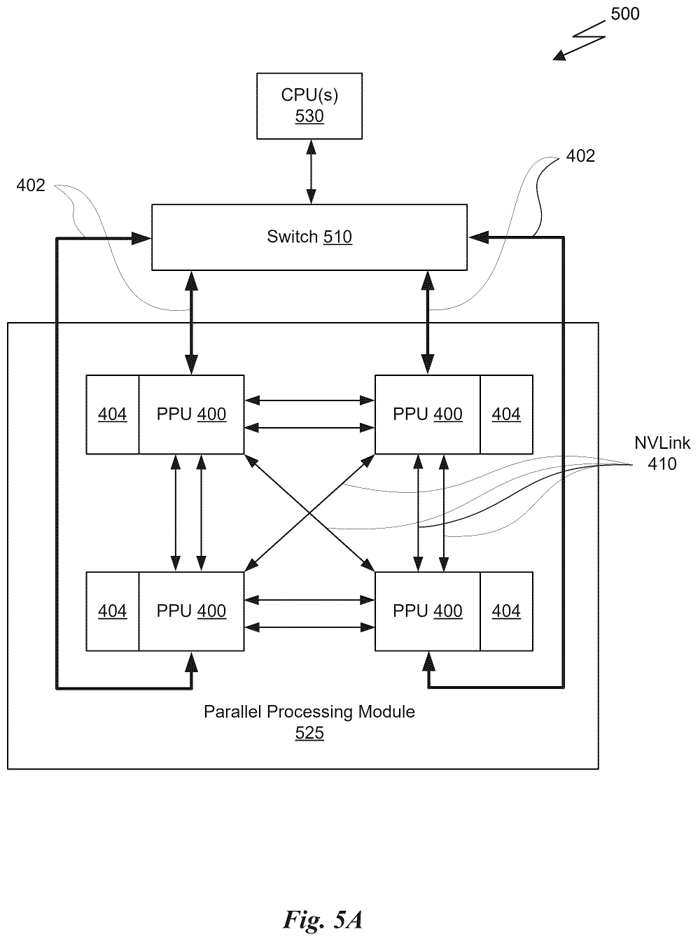

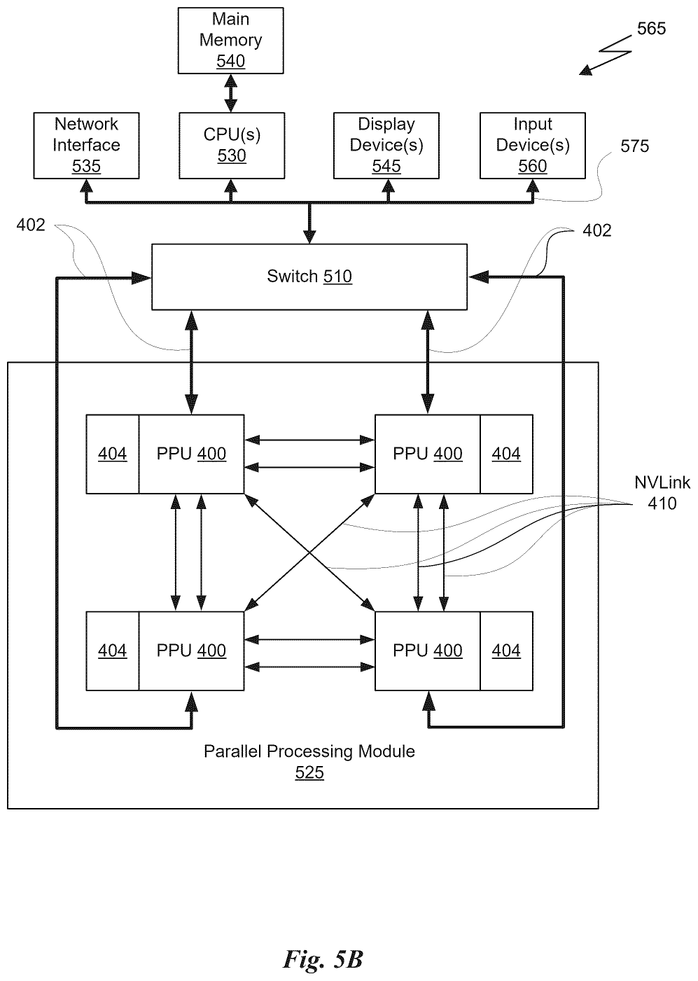

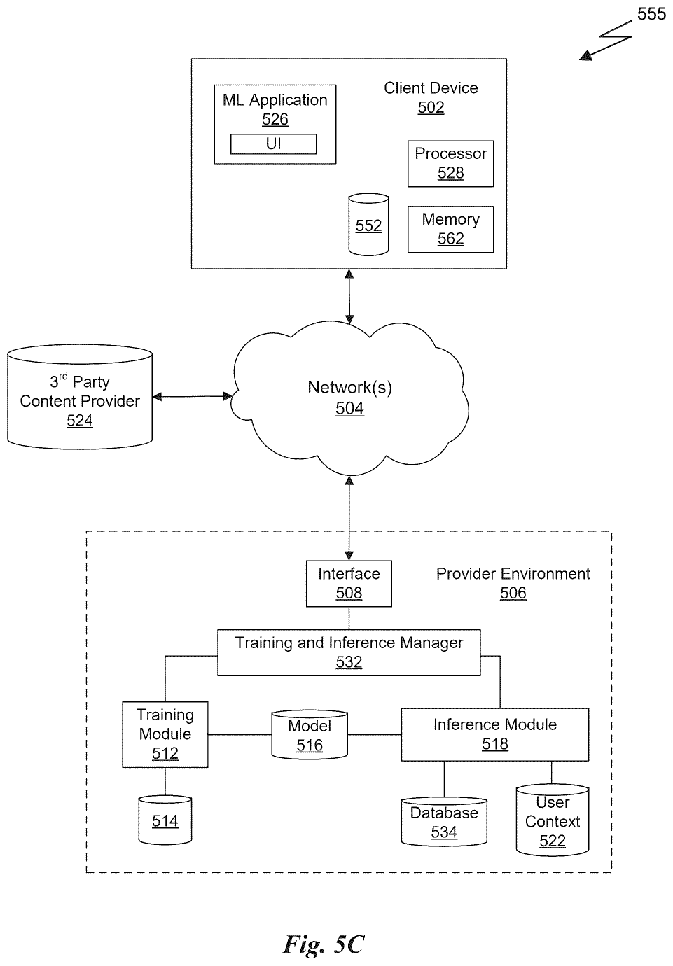

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QOS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32-bit, 64-bit, 128-bit, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in the L2 cache 460, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache 460 is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where cach thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, cach tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of cach NVLink 410 is 20 to 25 Gigabits/second and cach PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to cach PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5C are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5C is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5C.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., cach device) may be implemented on one or more instances of the processing system 500 of FIG. 5A and/or exemplary system 565 of FIG. 5B—e.g., cach device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment-and one or more client-server network environments-in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5B and/or exemplary system 565 of FIG. 5C. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In an embodiment, the set of training data may be used in a generative adversarial training configuration to train a generator neural network.

In at least one embodiment, training data can include images of at least one human subject, avatar, or character for which a neural network is to be trained. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Example Streaming System

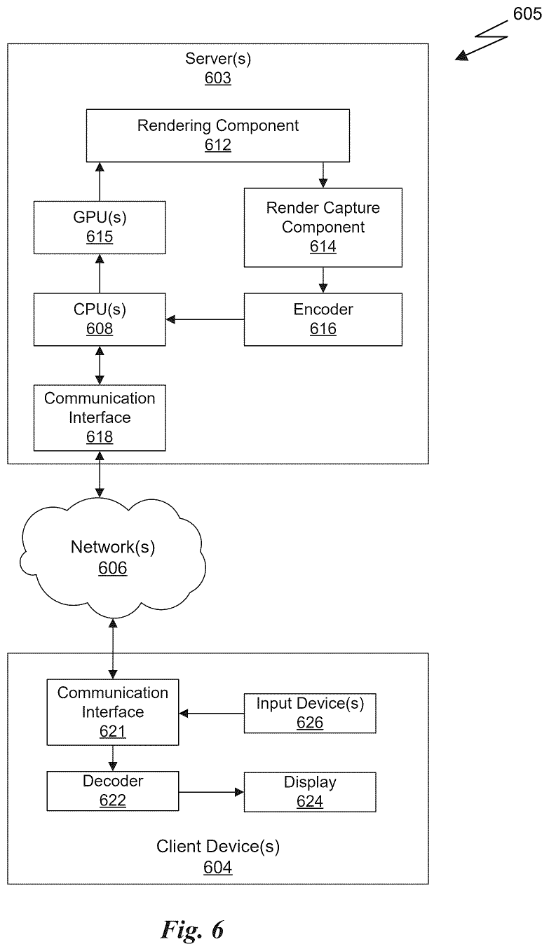

FIG. 6 is an example system diagram for a streaming system 605, in accordance with some embodiments of the present disclosure. FIG. 6 includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s), transmit the input data to the game server(s) 603, receive encoded display data from the game server(s) 603, and display the display data on the display 624. As such, the more computationally intense computing and processing is offloaded to the game server(s) 603 (e.g., rendering-in particular ray or path tracing-for graphical output of the game session is executed by the GPU(s) of the game server(s) 603). In other words, the game session is streamed to the client device(s) 604 from the game server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the game server(s) 603. The client device 604 may receive an input to one of the input device(s) and generate input data in response. The client device 604 may transmit the input data to the game server(s) 603 via the communication interface 621 and over the network(s) 606 (e.g., the Internet), and the game server(s) 603 may receive the input data via the communication interface 618. The CPU(s) may receive the input data, process the input data, and transmit data to the GPU(s) that causes the GPU(s) to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units-such as GPUs, which may further employ the use of one or more dedicated hardware accelerators or processing cores to perform ray or path-tracing techniques—of the game server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for multi-modal interaction, the method comprising:
receiving input comprising visual data;
generating one or more first textual tokens, the one or more first textual tokens corresponding to the visual data;
generating, by a large language model (LLM) and based on the one or more first textual tokens, one or more first output tokens;
generating, by a visual encoder and based on the visual data, one or more layers of visual features;
generating, by a visual embedding highway (VEH) network and based on the one or more layers of visual features, one or more visual controller signals; and
decoding, by a visual decoder and based on the one or more visual controller signals, the one or more first output tokens to generate visual output.

2. The computer-implemented method according to claim 1, wherein the visual decoder comprises a plurality of neural network layers, and the plurality of neural network layers comprise a set of downsampling layers and a set of upsampling layers,
wherein each downsampling layer of the set of downsampling layers in the visual decoder receives a visual controller signal of the one or more visual controller signals from the VEH network, and
wherein each visual control signal comprises a layer of visual features of the one or more layers of visual features from the visual encoder.

3. The computer-implemented method according to claim 2, further comprising:
generating, based on the one or more first output tokens, one or more textual controller signals,
wherein the decoding, by the visual decoder, the one or more first output tokens to generate the visual output is further based on the one or more textual controller signals,
wherein each downsampling layer of the set of downsampling layers in the visual decoder further receives a textual controller signal of the one or more textual controller signals, and
wherein each upsampling layer of the set of upsampling layers receives a textual controller signal of the one or more textual controller signals.

4. The computer-implemented method according to claim 1, wherein the visual data comprises at least one of image data or video data.

5. The computer-implemented method according to claim 1, wherein the generating the one or more first textual tokens comprises:
encoding, by the visual encoder, the visual data to generate a visual token sequence comprising one or more visual tokens; and
projecting, by a first visual projector, the one or more visual tokens into a textual embedding space to provide the one or more first textual tokens.

6. The computer-implemented method according to claim 5, wherein the visual encoder comprises at least one of an image encoder or a video encoder, and wherein the visual decoder comprises at least one of an image decoder or a video decoder.

7. The computer-implemented method according to claim 5, further comprising:
projecting, by a second visual projector, the one or more first output tokens from the textual embedding space into an embedding space corresponding to the visual decoder.

8. The computer-implemented method according to claim 7, further comprising:
at a first stage and using a first training dataset, training a plurality of first projectors, a plurality of second projectors, and a vocabulary embedding layer of the LLM, wherein the plurality of first projectors comprise the first visual projector, and wherein the plurality of second projectors comprise the second visual projector;
at a second stage, training the first and second projectors and fine-tuning the LLM, using a second training dataset; and
at a third stage, first fine-tuning the first projectors, the second projectors, and the LLM using the first training dataset, and then fine-tuning the visual decoder and the VEH network, wherein the visual decoder comprises at least one of an image decoder or a video decoder.

9. The computer-implemented method according to claim 8, wherein the first training dataset comprises cross-modality understanding and generation tasks, the cross-modality understanding and generation tasks comprising:
video to image tasks;
video to video tasks;
image to video tasks;
video to audio tasks;
audio to video tasks; and
image and audio to video tasks,
wherein the second training dataset comprises sets of data sequences sampled from a plurality of video clips, wherein each set of data sequences are sampled from a video clip of the plurality of video clips, wherein each data sequence comprises image, audio, video, and text input corresponding to a segment of the video clip, and wherein the set of data sequences correspond to different segments of the corresponding video clip, and
wherein at the second stage, the LLM is configured to predict missing segments of the plurality of video clips based on the sets of data sequences.

10. The computer-implemented method according to claim 1, further comprising:
generating, by the LLM, one or more second output tokens based on the visual token sequence, wherein the one or more second output tokens correspond to a modality different from the modality of the one or more first output tokens; and
generating additional output corresponding to the one or more second output tokens.

11. The computer-implemented method according to claim 1, wherein the input further comprises text data, the method further comprising:
encoding, by a tokenizer, the text data to generate a text token sequence in a textual embedding space, wherein the text token sequence comprises one or more second textual tokens;
generating, by the LLM and based on the one or more first textual tokens and the one or more second textual tokens, textual output.

12. The computer-implemented method according to claim 1, wherein the input further comprises audio data, the method further comprising:
encoding, by an audio encoder, the audio data to generate an audio token sequence comprising one or more audio tokens;
projecting, by an audio projector, the one or more audio tokens into a textual embedding space to provide one or more second textual tokens;
generating, by the LLM and based on the one or more first textual tokens and the one or more second textual tokens, one or more second output tokens; and
generating audio output based on the one or more second output tokens.

13. A system comprising:
one or more processors configured to perform, using one or more neural networks, generation of a multi-modal output based on input, the one or more neural networks comprising:
a visual encoder configured to:
encode visual input to generate a visual token sequence comprising one or more visual tokens; and
generate, based on the visual input, one or more layers of visual features;
a first visual projector configured to project the one or more visual tokens into a textual embedding space to provide one or more first textual tokens, the one or more first textual tokens corresponding to the visual input;
a large language model (LLM) configured to generate one or more first output tokens based on the one or more first textual tokens;
a visual embedding highway (VEH) network configured to generate, based on the one or more layers of visual features, one or more visual controller signals; and
a visual decoder configured to decode, based on the one or more visual controller signals, the one or more first output tokens to generate visual output.

14. The system according to claim 13, wherein the visual decoder comprises a plurality of neural network layers, and the plurality of neural network layers comprise a set of downsampling layers and a set of upsampling layers,
wherein each downsampling layer of the set of downsampling layers in the visual decoder receives a visual controller signal of the one or more visual controller signals from the VEH network, and
wherein each visual control signal comprises a layer of visual features of the one or more layers of visual features from a visual encoder.

15. The system according to claim 14, wherein the LLM is further configured to generate, based on the one or more first output tokens, one or more textual controller signals,
wherein the visual decoder is further configured to decode the one or more first output tokens based on the one or more textual controller signals,
wherein each downsampling layer of the set of downsampling layers in the visual decoder further receives a textual controller signal of the one or more textual controller signals, and
wherein each upsampling layer of the set of upsampling layers receives a textual controller signal of the one or more textual controller signals.

16. The system according to claim 13, wherein the visual input comprises at least one of image data or video data.

17. The system according to claim 13, wherein the LLM is further configured to:
generate one or more second output tokens based on the visual token sequence, wherein the one or more second output tokens correspond to a modality different from the modality of the one or more first output tokens; and
generate additional output corresponding to the one or more second output tokens.

18. The system according to claim 13, wherein the visual encoder comprises at least one of an image encoder or a video encoder, and wherein the visual decoder comprises at least one of an image decoder or a video decoder.

19. The system according to claim 13, the one or more neural networks further comprising:
a second visual projector configured to project the one or more first output tokens from the textual embedding space into an embedding space corresponding to the visual decoder.

20. The system according to claim 19, the one or more neural networks further comprising:
a tokenizer configured to encode text input to generate a text token sequence comprising one or more second textual tokens in the textual embedding space;
an audio encoder configured to encode audio input to generate an audio token sequence comprising one or more audio tokens; and
a first audio projector configured to project the one or more audio token into the textual embedding space to provide one or more third textual tokens, the one or more third textual tokens corresponding to the audio input,
wherein the LLM is further configured to generate one or more second output tokens corresponding to the one or more second textual tokens and one or more third output tokens corresponding to the one or more third textual tokens;
wherein the one or more neural networks further comprises:
a second audio projector configured to project the one or more third output tokens from the textual embedding space into an embedding space corresponding to an audio decoder; and
the audio decoder configured to decode the one or more third output tokens to generate audio output.

21. The system according to claim 20, wherein the one or more neural networks are trained by:
at a first stage and using a first training dataset, training a plurality of first projectors, a plurality of second projectors, and a vocabulary embedding layer of the LLM, wherein the plurality of first projectors comprise the first visual projector, and wherein the plurality of second projectors comprise the second visual projector;
at a second stage, training the first and second projectors and fine-tuning the LLM, using a second training dataset; and
at a third stage, first fine-tuning the first projectors, the second projectors, and the LLM using the first training dataset, and then fine-tuning the visual decoder and the VEH network, wherein the visual decoder comprises at least one of an image decoder or a video decoder.

22. The system according to claim 21, wherein the first training dataset comprises cross-modality understanding and generation tasks, the cross-modality understanding and generation tasks comprising:
video to image tasks;
video to video tasks;
image to video tasks;
video to audio tasks;
audio to video tasks; and
image and audio to video tasks,
wherein the second training dataset comprises sets of data sequences sampled from a plurality of video clips, wherein each set of data sequences are sampled from a video clip of the plurality of video clips, wherein each data sequence comprises image, audio, video, and text input corresponding to a segment of the video clip, and wherein the set of data sequences correspond to different segments of the corresponding video clip,
wherein at the second stage, the LLM is configured to predict missing segments of the plurality of video clips based on the sets of data sequences.

23. A non-transitory machine-readable medium having stored thereon a set of instructions, which if performed by one or more processors, cause the one or more processors to:
receive input comprising visual data;
generate one or more first textual tokens, the one or more first textual tokens corresponding to the visual data;
generate, by a large language model (LLM) and based on the one or more first textual tokens, one or more first output tokens;
generate, by a visual encoder and based on the visual data, one or more layers of visual features;
generate, by a visual embedding highway (VEH) network and based on the one or more layers of visual features, one or more visual controller signals; and
decode, by a visual decoder and based on the one or more visual controller signals, the one or more first output tokens to generate visual output.

24. The non-transitory machine-readable medium according to claim 23, wherein the visual decoder comprises a plurality of neural network layers, and the plurality of neural network layers comprise a set of downsampling layers and a set of upsampling layers,
wherein each downsampling layer of the set of downsampling layers in the visual decoder receives a visual controller signal of the one or more visual controller signals from the VEH network, and
wherein each visual control signal comprises a layer of visual features of the one or more layers of visual features from the visual encoder.

25. The non-transitory machine-readable medium according to claim 24, wherein the set of instructions further cause the one or more processors to:
generate, based on the one or more first output tokens, one or more textual controller signals, wherein the decoding, by the visual decoder, the one or more first output tokens to generate the visual output is further based on the one or more textual controller signals,
wherein each downsampling layer of the set of downsampling layers in the visual decoder further receives a textual controller signal of the one or more textual controller signals, and
wherein each upsampling layer of the set of upsampling layers receives a textual controller signal of the one or more textual controller signals.
